(19) United States
(12) Patent Application Publication
(10) Pub. No.: US 2025/0139198 A1
(43) Pub. Date: May 1, 2025

(54) SYSTEM AND METHOD FOR FAST PROCESSING SINGULAR VALUE DECOMPOSITION (SVD) OF EXTREMELY LARGE-SCALE LOW-RANK MATRICES

(71) Applicant: Centre for Intelligent Multidimensional Data Analysis Limited, Pak Shek Kok (HK)

(72) Inventors: Muhmmad Ashraf Abdelhmid Abdelgawad, Pak Shek Kok (HK); Hong Yan, Pak Shek Kok (HK); Chak Chung Ray Cheung, Pak Shek Kok (HK); Qixuan Zheng, Pak Shek Kok (HK)

(21) Appl. No.: 18/497,389

(22) Filed: Oct. 30, 2023

(51) Int. Cl. G06F 17/17; G06F 17/16

(52) U.S. Cl. CPC G06F 17/175; G06F 17/16

(57) ABSTRACT

A computer-implemented method for generating an approximation image of a matrix A, the computer-implemented method including: constructing in a processing unit a C, U, R matrices decomposition of matrix A wherein C includes k column vectors and R includes k row vectors retrieved from a storage memory holding the matrix A; performing in the processing unit Singular Value Decomposition on the C, U, and R to generate the approximation matrix UₖΣₖVₖ^{T} of the matrix A such that A≈UₖΣₖVₖ^{T}.

### TECHNICAL FIELD

The invention relates to a system and a method of fast processing Singular Value Decomposition (SVD) of extremely large-scale low-rank matrices.

### BACKGROUND

The matrix decomposition method has significant roles in computer applications such as computational mechanics, complex networks, machine learning, data analysis, image processing, and signal processing.

These computer applications that require the handling of large-scale low-rank matrices will always be executed in computer systems with limited resources. Growing requirements to process, analyze, and interpret such high-dimensional data, have led to methods to approximate the matrix with low-rank counterparts for practical applications. One of the most widely used methods for low-rank matrix analysis is singular value decomposition (SVD), a fundamental tool in linear algebra, statistics, and machine learning. SVD for dimensionality reduction techniques, e.g., principal component analysis (PCA), maps data from a high dimensional into a low dimensional space. The SVD of a real matrix A ε [symbol] is A=UΣV^{T}, where U ε [symbol] and V ε [symbol] are orthogonal matrices representing the left and right singular vectors, respectively, and Σ is an m×n diagonal matrix of singular values in descending order.

Although SVD provides the optimal low-rank approximation, it requires costly storage and long computing time that are prohibitive for large-scale matrices on ordinary desktop computers. Optimal SVD of a dense, low-rank (k) matrix A of size m by n requires 0(mn²+m²n+n³) time. If optimality is not required, computationally efficient low-rank approximations by randomized projection methods can be used to approximate the dominant subspace of the data matrix. Lanczos methods, for example, have time complexity 0(mnk²). Still, the whole data matrix is stored, the rank must be known in advance, and the process remains computationally expensive, especially for data projection.

Classical or randomized SVD approaches for large data require reading the whole data at least once, storage of substantial temporary matrices during computation, and large matrix multiplications during their projection steps.

The prior art matrix decomposition methods are slow and limited by the system specification making it not scalable

U.S. Pat. No. 10,229,092 discloses a low-rank matrix approximation method using low-rank matrix factorization in the lₚ-norm space, where p<2 (e.g., 1≤p<2). This method uses low-rank matrix factorization in the least absolute deviation (l₁-norm) space providing an l₁-PCA technique. This method minimizes the lₚ-norm of the residual matrix in the subspace factorization of an observed data matrix, such as to minimize the l₁-norm of the residual matrix where p=1. The alternating direction method of multipliers (ADMM) is applied to solve the subspace decomposition of the low-rank matrix factorization with respect to the observed data matrix. Iterations of the ADMM may comprise solving a subspace decomposition and calculating the proximity operator of the l₁-norm. However, this method is time-consuming and does not scale well for large matrices.

U.S. Pat. No. 9,760,537 discloses a computer-implemented method for finding a CUR decomposition. The method includes constructing, by a computer processor, a matrix C based on a matrix A. A matrix R is constructed based on the matrix A and the matrix C. A matrix U is constructed based on the matrices A, C, and R. The matrices C, U, and R provide a CUR decomposition of the matrix A. The construction of the matrices C, U, and R provide at least one of an input-sparsity-time CUR and a deterministic CUR. this method is time-consuming and does not scale well for large matrices.

### SUMMARY OF THE INVENTION

In accordance with a first aspect of the present invention, there is provided computer-implemented method for generating an approximation image of a matrix A, the computer-implemented method comprising:
constructing in a processing unit a C, U, R matrices decomposition of matrix A wherein C comprises k column vectors and R comprises k row vectors retrieved from a storage memory holding the matrix A;
performing in the processing unit Singular Value Decomposition on the C, U, and R to generate the approximation matrix UₖΣₖVₖ^{T} of the matrix A such that A≈UₖΣₖVₖ^{T}.

In accordance with the first aspect, the C and R matrices comprise columns and rows of A given by indices I and J generated randomly from a uniform distribution.

In accordance with the first aspect, the matrix U is an optimal solution of U=Cᵤ^{†}AᵤRᵤ^{†}, wherein rows and columns of Aᵤ are retrieved from the storage memory holding the matrix A using deterministic sampling method.

In accordance with the first aspect, the deterministic sampling method is a discrete empirical interpolation method (DEIM).

In accordance with the first aspect, the step of the Singular Value Decomposition on the C and R comprising generating matrices [U_{c},S_{c},V_{c}] and [Uᵣ,Sᵣ,Vᵣ], such that C=U_{c}S_{c}V_{c}^{T} and R=UᵣSᵣVᵣ^{T}.

In accordance with the first aspect, the step of Singular Value Decomposition on the C, U, and R comprises the step of generating a matrix Z, such that Z=S_{c}V_{c}^{T}UUᵣSᵣ.

In accordance with the first aspect, the approximation matrix UₖΣₖVₖ^{T} is generated by the Singular Value Decomposition on the intermediate matrix Z, such that Z=U_{z}S_{z}V_{z}^{T}.

In accordance with the first aspect, Uₖ=U_{c}U_{z}, Σₖ=S_{z}, and Vₖ=VₖVᵣ.

In accordance with the first aspect, k is greater than a rank of the matrix A.

In accordance with the first aspect, k is an arbitrary integer.

In accordance with the first aspect, an error tolerance ε is stored in memory of the processing unit.

In accordance with the first aspect, distance functions for the Singular Values of C and R, δ_{c}=|σ_{c}^{k}−σ_{c}^{k-1}| and δᵣ=|σᵣ^{k}−σᵣ^{k-1}| are generated, wherein S_{c}=diag(σ_{c}¹, . . . ,σ_{c}^{k}) and Sᵣ=diag(σᵣ¹, . . . ,σᵣ^{k}).

In accordance with the first aspect, if one of the distance functions returns a value greater than the error tolerance ε,k will be increased to construct in the processing unit a new C and R matrices decomposition with increased rows and columns until the distance functions return a value less than the error tolerance ε.

In accordance with the first aspect, the processing unit is adapted to compute the approximation matrix UₖΣₖVₖ^{T} using partial elements of the matrix A.

In accordance with the first aspect, the processing unit comprises cache memory or random access memory having a size less than a size required to hold the matrix A.

In accordance with the first aspect, wherein the processing unit is adapted to load only the partial elements of matrix A to cache memory or random access memory for processing.

In accordance with the first aspect, the matrix A comprises a plurality of digital images.

In accordance with the first aspect, each digital image is represented as a column vector in matrix A.

In accordance with the first aspect, the matrix A comprises time series data wherein each column vector represents a snapshot data of a time interval.

### BRIEF DESCRIPTION OF THE DRAWINGS

Embodiments of the present invention will now be described, by way of example, with reference to the accompanying drawings in which:

FIG. 1 is a schematic diagram of a computer server which is arranged to be implemented as system for analyzing compressed video in accordance with an embodiment of the present invention.

FIG. 2 is a block diagram showing a computer-implemented method for in accordance with an embodiment of the present invention.

FIG. 3a include diagrams showing comparisons between fixed rank CUR-SVD, SVD, SVD single pass, and SVD randQB methods for computational time and memory usage when computing the top k singular values and vectors for different matrix sizes and different values of k.

FIG. 3b include diagrams showing comparisons between fixed rank CUR-SVD, SVD, SVD single pass, and SVD randQB methods for computational time and memory usage when computing the top k singular values and vectors for different matrix sizes and different values of k.

FIG. 4a include diagrams showing comparisons of fixed rank CUR-SVD, SVD, SVD single pass, and SVD randQB methods for the accuracy of approximation (relative error) when computing the top k singular values and vectors for different matrix sizes and different values of k.

FIG. 4b include diagrams showing the accuracy of the resultant singular values for three matrices with different singular value distributions (slow, fast, and S-shape decay).

FIG. 5a include diagrams showing effects of parameters (block size, error tolerance, and size of matrices) of the fixed precision CUR-SVD method of the present invention on the estimated rank, run time, relative error, and memory usage with the performance of the SVD method.

FIG. 5b include diagrams showing effects of parameters (block size, error tolerance, and size of matrices) of the fixed precision CUR-SVD method of the present invention on the estimated rank, run time, relative error, and memory usage with the performance of the SVD method.

FIG. 6a include diagrams showing the extended Yale B faces dataset, with performance evaluation of CUR-SVD for PCA on the dataset, setting k to 300, there are 38 individuals and each has 64 images of size (168×192), which can be reshaped into a 32256×2432 matrix.

FIG. 6b include diagrams showing the extended Yale B faces dataset, with performance evaluation of CUR-SVD for PCA on the dataset, setting k to 300, there are 38 individuals and each has 64 images of size (168×192), which can be reshaped into a 32256×2432 matrix.

FIG. 6c include diagrams showing the extended Yale B faces dataset, with performance evaluation of CUR-SVD for PCA on the dataset, setting k to 300, there are 38 individuals and each has 64 images of size (168×192), which can be reshaped into a 32256×2432 matrix.

FIG. 6d include diagrams showing the extended Yale B faces dataset, with performance evaluation of CUR-SVD for PCA on the dataset, setting k to 300, there are 38 individuals and each has 64 images of size (168×192), which can be reshaped into a 32256×2432 matrix.

FIG. 6e include diagrams showing performance evaluation of CUR-SVD for PCA on the extended Yale B faces dataset of FIGS. 6A, 6B, 6C and 6D, which sets k to 300, there are 38 individuals and each has 64 images of size (168×192), which can be reshaped into a 32256×2432 matrix

FIG. 6f include diagrams showing performance evaluation of CUR-SVD for PCA on the extended Yale B faces dataset of FIGS. 6A, 6B, 6C and 6D, which sets k to 300, there are 38 individuals and each has 64 images of size (168×192), which can be reshaped into a 32256×2432 matrix

FIG. 7a include diagrams showing the performance of the proposed fixed k (i.e., CUR-SVD) method under different construction of U matrix based on (i.e., CUR-SVD(I), CUR-SVD(O), and CUR-SVD(D). For CUR-SVD(I) and CURSVD(O).

FIG. 7b include diagrams showing the performance of the proposed fixed k (i.e., CUR-SVD) method under different construction of U matrix based on (i.e., CUR-SVD(I), CUR-SVD(O), and CUR-SVD(D). For CUR-SVD(I) and CURSVD(O).

FIG. 8 include diagrams showing Singular value approximation comparison between the proposed fixed rank CUR-SVD and ground truth with matrix size is 1,000,000×1,000,000 with rank=100.

FIG. 9 include diagrams showing accuracy validation of singular vectors computed by fixed rank k algorithm compared to SVD method under different singular values distributions.

### DETAILED DESCRIPTION OF THE PREFERRED EMBODIMENTS

The present invention is designed to address two problems in current computing systems which have physical limitations in the working memory and non-volatile storage: (1) representing large-scale data matrices using a small number of a few rows and columns, thereby addressing the memory issue; and (2) computing a satisfactory approximation of the SVD of the original matrix with these partial data sets.

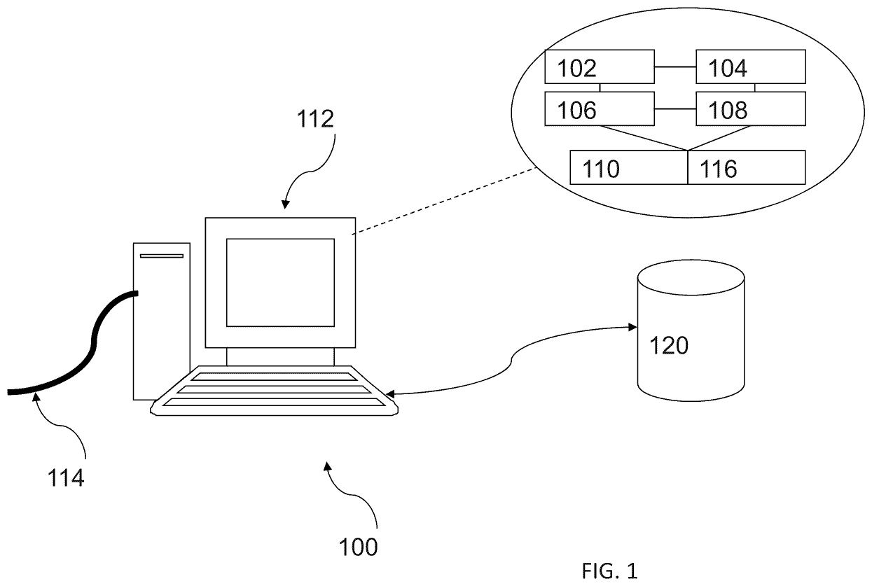

The method of the present invention can be implemented in a computing system as shown in FIG. 1 or any embedded system to provide a significant improvement in speed and performance for handling applications that require manipulations of large-scale data matrices, such as Al matching engine, convolution neural network, etc.

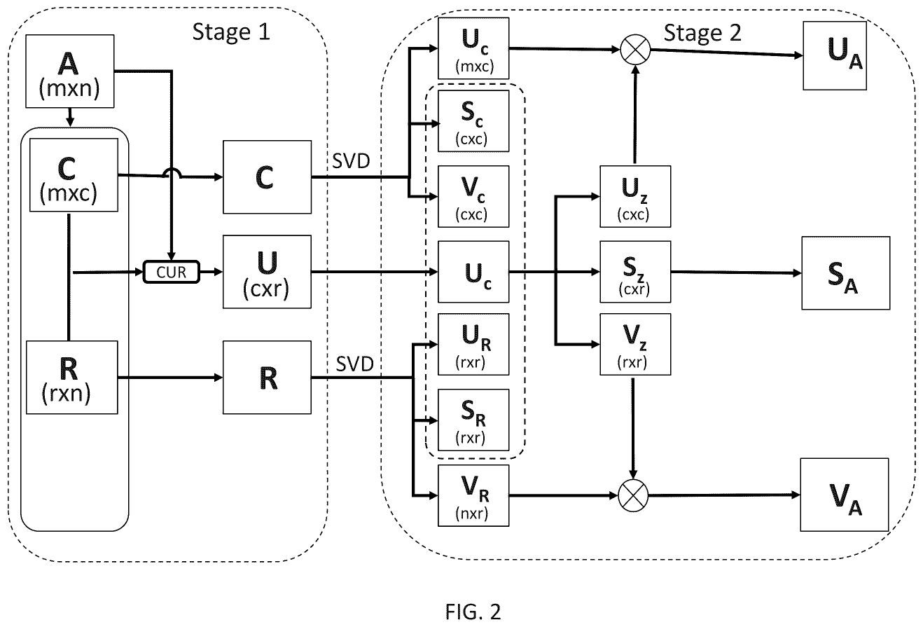

In a preferred embodiment of the present invention, there is provide a computer-implemented method for generating an approximation image of a matrix A as shown in FIG. 2. The computer-implemented method comprises the step of constructing in a processing unit a C, U, R matrices decomposition of matrix A wherein C comprises k column vectors and R comprises k row vectors retrieved from a storage memory holding the matrix A, and then proceeds to the step of performing in the processing unit Singular Value Decomposition on the C, U, and R to generate the approximation matrix UₖΣₖVₖ^{T} of the matrix A such that A≈uₖΣₖVₖ^{T}. In one embodiment, the processing unit comprises cache memory or associated with random access memory with limited capacity. Typically, the capacity of the cache and RAM is less than the size required to holding the matrix A. The matrix A will be stored in a hard drive during the execution of the method of the present invention. The processing unit is adapted to compute the approximation matrix UₖΣₖVₖ^{T} using partial elements of the matrix A.

The C and R matrices comprises columns and rows of A given by indices I and J generated randomly from a uniform distribution. The matrix U is an optimal solution of U=Cᵤ^{†}AᵤRᵤ^{†}, wherein row and column of Cᵤ, Aᵤ, and Rᵤ are retrieved from the storage memory holding the matrix A using deterministic sampling method. The processing unit is adapted to load only the partial elements of matrix A to cache memory or random access memory for processing the method of the present invention.

The deterministic sampling method is a discrete empirical interpolation method (DEIM). The step of the Singular Value Decomposition on the C and R comprising generating matrices [U_{c},S_{c},V_{c}] and [Uᵣ,Sᵣ,Vᵣ], such that C=U_{c}S_{c}V_{c}^{T} and R=UᵣSᵣVᵣ^{T}. The step of Singular Value Decomposition on the C and R comprises the step of generating a matrix Z, such that Z=S_{c}V_{c}^{T}UUᵣSᵣ. The approximation matrix UₖΣₖVₖ^{T} is generated by the Singular Value Decomposition on the intermediate matrix Z, such that Z=U_{z}S_{z}V_{z}^{T}, wherein Uₖ=U_{c}U_{z}, Σₖ=S_{z}, and Vₖ=V_{z}Vᵣ.

The value k is greater than a rank of the matrix A. In one embodiment, k is an arbitrary integer.

In one embodiment, when the rank of the matrix A is unknow, multiple Singular Value

Decomposition of C and R will be generated with an increment block size of C and R until the difference between 2 consecutive iterations is less than an error tolerance.

This method comprises the step of assigning an error tolerance ε is stored in memory of the processing unit. The distance functions for the Singular Value Decomposition of C and R, δ_{c}=|σ_{c}^{k}−σ_{c}^{k-1}| and δᵣ=|σᵣ^{k}−σᵣ^{k-1}| are generated, wherein S_{c}=diag(σ_{c}¹, . . . ,σ_{c}^{k}) and Sᵣ=diag(σᵣ¹, . . . ,σᵣ^{k}). When one of the distance functions returns a value greater than the error tolerance ε, k will be increased to construct in the processing unit a new C and R matrices decomposition with increased columns and rows until the distance functions return a value less than the error tolerance ε.

The algorithm of an embodiment of the present invention has a lot of applications, such as images processing and artificial intelligence. Typically, for image processing, the matrix A comprises a plurality of digital images and each digital image is represented as a column vector in matrix A. In another application, the matrix A comprises time series data wherein each column vector represents a snapshot data of a time interval.

To provide a solution for both problems, the present invention provides a novel, highly efficient method, CUR-SVD, to compute the top k singular vectors and values of a large-scale matrix by exploiting its low-rank structure. Most large-scale data matrices in practical applications have low-rank structures or can be well-approximated by low-rank matrices, allowing the large-scale data matrices to be represented by only a small portion of rows and columns. If that representation has sufficiently high accuracy, efficient computation of the SVD can be performed for applications where this was not previously possible.

Interpretable and computationally efficient approaches based on selecting rows and columns from a data matrix, represent data in lower dimensional spaces with actual data points as basis vectors to maintain sparseness or nonnegativity, as in CUR matrix decomposition, which represents the data matrix as a product of three small matrices. CUR of matrix A ε [symbol] is a low-rank approximation A≈CUR where C ε [symbol] and R ε [symbol] matrices are formed by extracting c columns and r rows of A, respectively, where c,r≥rank (A). U is constructed to make the approximation error very small. Randomized approaches for CUR decomposition sample columns and rows based on uniform or non-uniform distributions while deterministic approaches consider the approximation as an optimization problem and try to find the best decomposition that minimizes the approximation error. Low-rank approximation methods form two categories: (1) fixed-rank, where the rank of A is known, and (2) fixed-precision, where the rank is estimated by making the error between A and its approximation Aₐₚₚ as small as possible ∥A−Aₐₚₚ∥_{F}<ε, where ε is a given accuracy tolerance).

The system or method of the present invention is adapted to handle large-scale matrices that are prohibitively large to store in random access memory (RAM) or processing unit caches for computing their SVD. Two algorithms to be executed by a computing system or processing unit (fixed rank CUR-SVD and fixed precision CUR-SVD) are proposed in the present invention to compute the top k singular vectors and their corresponding singular values of large-scale, low-rank data for the cases where the rank is known or unknown respectively.

To validate the accuracy and efficiency of the systems or methods of the present invention in practical scenarios, numerical experiments were conducted on a desktop computer with datasets of different sizes and low-rank structures to demonstrate the effectiveness of CUR-SVD. The system or method of the present invention is shown to provide comparable approximation accuracy to existing SVD algorithms for large-scale low-rank matrices but was much more efficient in terms of computational time and storage. The top 200 singular vectors and their corresponding singular values of a 1 million by 1 million matrix were calculated in about 3 and 15 minutes for the fixed-rank and fixed-precision algorithms, respectively, with a tiny approximation error and memory utilization of less than 3 GB. This makes CUR-SVD feasible on most current computing devices. Traditional methods would have required 7.27 TB of memory, which is impractical.

In this example embodiment, the systems and methods of the present invention are implemented by a computer or processor. The computer may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the invention.

As shown in FIG. 1 there is a shown a schematic diagram of a computer system or computer server 100 which is arranged to be implemented as an example embodiment of a system for analyzing compressed video. In this embodiment the system comprises a server 100 which includes suitable components necessary to receive, store and execute appropriate computer instructions. The components may include a processing unit 102, including Central Processing Unit (CPUs), Math Co-Processing Unit (Math Processor), Graphic Processing Unit (GPUs) or Tensor Processing Unit (TPUs) for tensor or multi-dimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114. The server 100 may include instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices, Internet of Things (IoT) devices, smart devices, edge computing devices. At least one of a plurality of communications links may be connected to an external computing network through a telephone line or other type of communications link. Without loss of generality, the processing unit 102, ROM 104, RAM 106, and disk drives 108 have finite physical limits. For example, the processing 102 may have 30 MB cache memory and may support up to 192 GB of RAM.

The Server 100 may include storage devices such as a disk drive 108 which may encompass solid state drives, hard disk drives, optical drives, magnetic tape drives or remote or cloud-based storage devices. The server 100 may use a single disk drive or multiple disk drives, or a remote storage service 120. The server 100 may also have a suitable operating system 116 which resides on the disk drive or in the ROM of the server 100.

The computer or computing apparatus may also provide the necessary computational capabilities to operate or to interface with a machine learning network, such as neural networks, to provide various functions and outputs. The neural network may be implemented locally, or it may also be accessible or partially accessible via a server or cloud-based service. The machine learning network may also be untrained, partially trained or fully trained, and/or may be retrained, adapted or updated over time.

The CUR-SVD algorithm to be executed in a processing unit of a computing system of the present invention consists of two stages: constructing a CUR decomposition and performing SVD on the small decomposed C and R matrices. It is highly efficient in computational time and storage to compute the SVD of large-scale matrices compared with existing methods. The large-scale matrices sometimes be too big to store in computer memory. Therefore, the CUR-SVD algorithm of the present invention can be utilized in other valuable applications, such as efficient computation of the inverses of extremely large-scale low-rank matrices.

The method depicted in FIG. 2 may be implemented on a computer system in hardware, software, or a combination thereof. FIG. 2 shows an overview of the fixed-rank CUR-SVD method to compute the SVD of large-scale, low-rank matrices. CUR-SVD consists of two stages: constructing the CUR decomposition and performing SVD on the small decomposed matrices C and R. CUR-SVD has very high computational and storage efficiency for computing SVD of large-scale matrices compared to the existing methods.

The Fixed (Know) Rank CUR-SVD Method

For a large-scale matrix A ε [symbol] , with low-rank structure rank (A)=ρ<<min {m,n}, randomly select c columns of A to form C ε [symbol] , where c>ρ. Then, with high probability, C will capture the column span of A. Similarly, randomly select r rows of A to form R ε [symbol] , where r>ρ. Then, with high probability, R captures the row span of A. The large-scale matrix A represented by CUR decomposition is A≈CUR, where U is the link between the column and row spans of A, which makes the approximation error very small. Hence, the left and right singular vectors and values of A can be obtained from the small matrices C, U, and R without having to load the large-scale matrix A into memory, as presented in the first stage of FIG. 2.

Following is the pseudo-code of Algorithm 1 for generating an approximation decomposition matrix of A where A≈UₖΣₖVₖ^{T}.

Algorithm 1: Fixed rank CUR-SVD algorithm for large-scale
low-rank matrices

Input: A [symbol] and k is the number of rows and columns of A to select, k >> ρ.
Output: Uₖ, Σₖ and Vₖ, with A ≈ UₖΣₖVₖ^{T}

| | | |
|---|---|---|
| 1. | I ← Uniformly and independently generated r row indices; | // Where I ⊂ [m] and r = k. |
| 2. | J ← Uniformly and independently generated c column indices; | // Where I ⊂ [n] and c = k. |
| 3. | Get the selected c columns to form C = A(:, J); | |

| 4. | Get the selected r rows to form R= A(I, :); | |
|---|---|---|
| 5. | [U_{c},S_{c},V_{c}] = SVD(C); | // Compute the economy-size SVD C ∈ [symbol] |
| 6. | [Uᵣ,Sᵣ,Vᵣ] = SVD(R); | // Compute the economy-size SVD of R ∈ [symbol] |
| 7. | J′ = DEIM(Vᵣ); | // Get more r column indics using the DEIM algorithm. |
| 8. | I′ = DEIM(U_{c)}; | // Get more c row indices using DEIM algorithm. |

| | | |
|---|---|---|
| 9. | J″ = unique [J, J′]; I″ = unique[I; I′] | // Remove the duplicated indices. |
| 10. | Cᵤ = C(I″, :); | // Where Cᵤ ∈ [symbol] ^{\|I″\|×c} |
| 11. | Rᵤ = R(:, J″); | // Where Rᵤ ∈ [symbol] ^{R×\|J″\|} |
| 12. | Aᵤ = A(I″,J″); | // Where Aᵤ ∈ [symbol] ^{\|I″\|×\|J″\|} |
| 13. | U = Cᵤ^{†}AᵤR_{U}^{†} | // Where U ∈ [symbol] |
| 14. | Z = S_{c}V_{c}TUUᵣSᵣ; | // the intermediate matrix Z ∈ [symbol] |
| 15. | [U_{Z},S_{Z},V_{Z}] = SVD(Z); | // Compute the full-sized SVD of Z |
| 16. | Return Uₖ ≡ U_{c}U_{Z}, Σₖ ≡ S_{Z}, Vₖ ≡ V_{Z}Vᵣ; | |

Algorithm 1 presents the pseudo-code of the fixed rank CUR-SVD method, which computes the top k singular vectors and values of the large-scale matrix A as A≈UₖΣₖVₖ^{T}, using the small matrices of the CUR decomposition of A. The first stage constructs the CUR decomposition of A using only k (for simplicity assume c=r=k) rows and columns from A, and the second stage computes the k-SVD of A using the matrices of the CUR decomposition.

Inputs are the matrix A, k>>ρ, that is the number of rows and columns to be selected to form C and R, which is larger than the rank of A. The indices of the rows and columns, I and J, are generated randomly from a uniform distribution with the R and C matrices formed from the rows and columns of A given by I and J.

Effect of the U matrix: Matrix U of the CUR decomposition needs to be constructed to make the approximation error ∥A−CUR∥_{F}² or ∥A−CUR∥₂ as small as possible. The simplest method, the pseudoinverse of the intersection matrix between C and R, gives a high approximation error for high rank or noisy data. The optimal solution is U=C^{†}AR^{†} where U is formed by weighting all elements of A, giving a small approximation error but at high computational expense, especially for large-scale matrices. To balance approximation accuracy and computational complexity, it is proposed to form U by selecting more rows from C and more columns from R, instead of the intersection between c columns and r rows, and then compute U using the optimal form. More rows and columns from C and R are obtained by a deterministic sampling method, called discrete empirical interpolation method (DEIM), that captures the most informative rows and columns using the information of singular vectors. DEIM is a point selection algorithm originally used to model order reduction in nonlinear dynamical systems that have been used as a fully deterministic algorithm to improve the error boundary when forming C and R in CUR decomposition.

Algorithm 3 shows the procedures to compute the selected row (and similarly column) indices/by the DEIM algorithm. The input is the full rank matrix U ε [symbol] that contains the top-k left singular vectors. The algorithm processes one singular vector at a time, and each vector provides one index, as shown in Steps 2 to 9. Therefore, the maximum number of generated indices is the number of available singular vectors, k.

Algorithm 3: DEIM selection points algorithm

| 1 | | Function DEIM(U): | |
|---|---|---|---|
| 2 | \| | u = U(:, 1) | / / U∈ [symbol] left singular vectors matrix (m ≥ k); |

| 3 | \| | [~, p1] = max(\|u\|); | | |
|---|---|---|---|---|
| 4 | \| | I = [p1]; | | |
| 5 | \| | for i = 2, 3, . . . , k do | | |
| 6 | \| | \| | u = U(:, i); | |
| 7 | \| | \| | c = U(I, 1 : i − 1)−1u(I); | |
| 8 | \| | \| | r = u − U(:, 1 : i − 1)c; | |
| 9 | \| | \| | [~,pi] = max(\|r\|); | |
| 10 | \| | \| | I = [I; pi] | // I is the output k indices |

corresponding to k singular vectors;

| | | |
|---|---|---|
| 11 | \| | end for |

After constructing C and R, their SVD is computed to give U_{c} ε [symbol] , S_{c} ε [symbol] , V_{c} ε [symbol] , Uᵣ ε [symbol] , Sᵣ ε [symbol] , and V_{c} ε [symbol] , as shown in Lines 5 and 6 of Algorithm 1 and the second stage of FIG. 1. Now, the left singular vectors of C (U_{c}) and right singular vectors of R (Vᵣ) are available, so DEIM is applied to obtain k indices of rows of C and k indices of columns of R. To avoid duplication, any repeated indices are removed. Then Cᵤ, Rᵤ and the intersection between them (Aᵤ), as shown in Lines 10 to 12 of algorithm 1 are constructed. The optimal form of SVD is used to compute U using an intersection between ((≤2k) rows and (≤2k) columns, where (c=r=k).

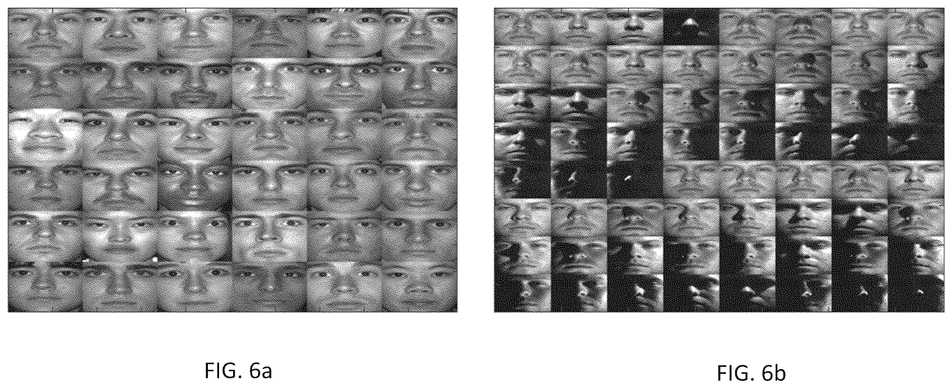

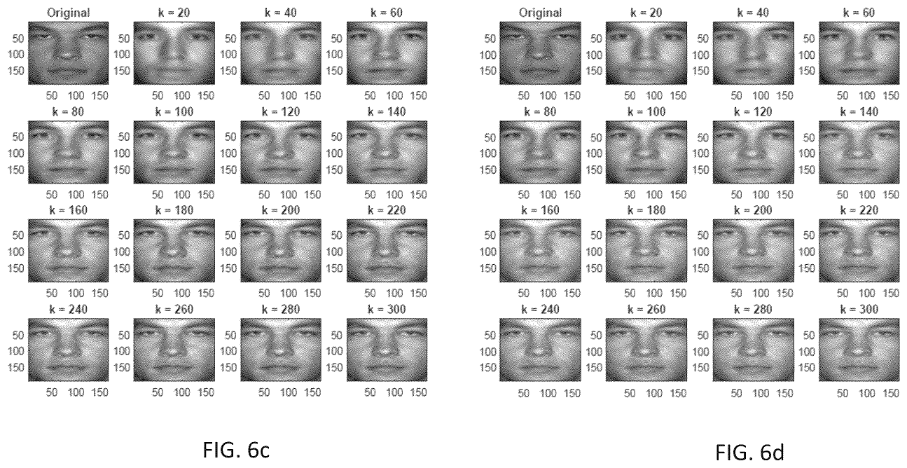

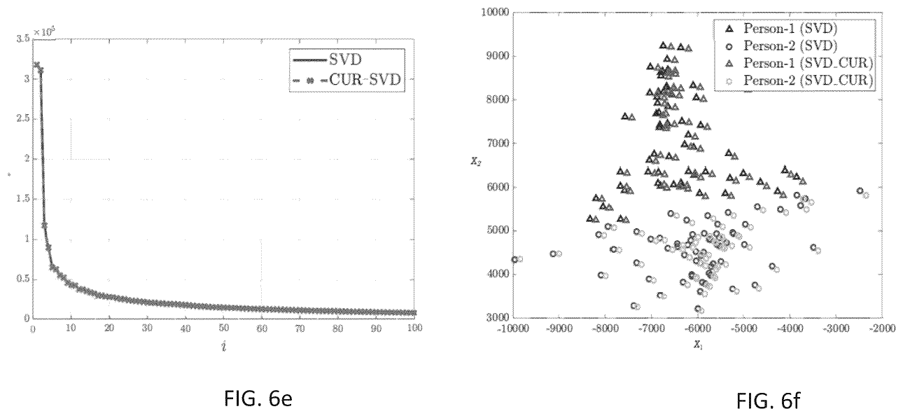

CUR-SVD of the U matrix based on the intersection, optimal solution, and the DEIM method, are denoted as CUR-SVD(I), CUR-SVD(O), and CUR-SVD(D), respectively. FIG. 6 demonstrates the effect of U on the runtime and approximation error. All methods provide an exact result for k greater than 20, which is the rank of A. The effect of the U matrix on computational time and approximation error. As can be seen, all methods provide an exact approximation for k greater than 20, which is the rank of A. For k less than the rank of A, the approximation error is very high and not stable for CUR-SVD(I), but the CUR-SVD(O) and CUR-SVD(D) methods have almost the same relative error values, which are comparable with the SVD.

For k less than the rank of A, the approximation error is high and not stable for CUR-SVD(I), but similar to SVD for CUR-SVD(O) and CUR-SVD(D). FIG. 6b shows their run times. CUR-SVD(D) requires a slightly higher run time than CUR-SVD(I), but both are faster than CUR-SVD(O). Subsequently, the CUR-SVD(D) method was used for the construction of U.

Only C, U, and R, a total of (mc+nr+rc) elements, instead of the of the whole A matrix, are considered, and computation of the SVD of A, with complexity [symbol] (m min{m,n}²), is replaced by computing the SVD of C, Z, and R with complexities [symbol] (mk²), [symbol] (k²), [symbol] (nk²), respectively.

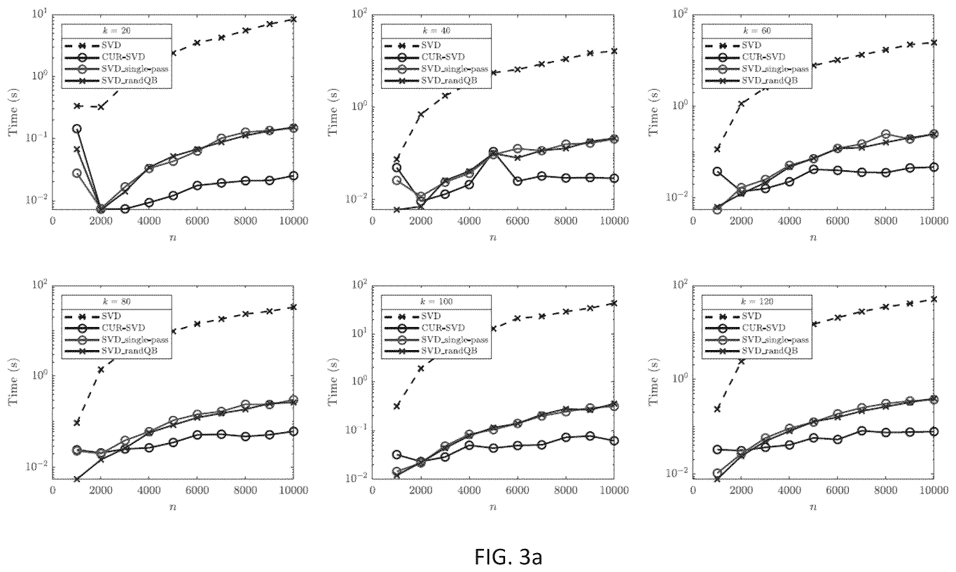

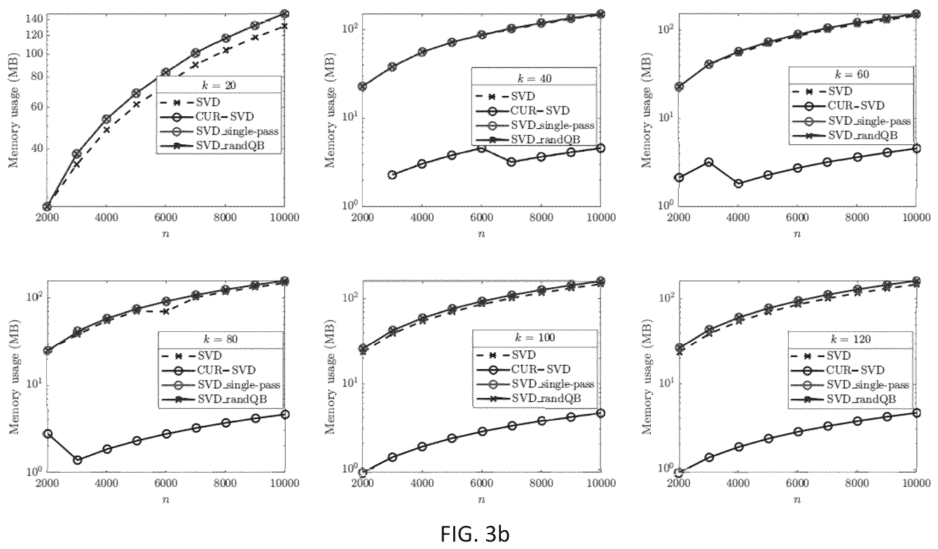

All experiments were implemented with MATLAB R2022a on a desktop computer with an Intel® Core™ i7-10700 processor @ 2.90 GHz, and 16 GB RAM. FIG. 3a shows the run time performance of the different methods for different matrix sizes and different values of k. The original SVD method provided in MATLAB is the most computationally expensive and CUR-SVD outperforms the other methods. When computing the top k singular values and vectors, CUR-SVD outperforms all other methods in terms of the memory required for computing k-SVD (FIG. 3b). For a matrix of size 10,000 by 10,000, CUR-SVD requires only about 10 MB to compute the top 120 singular vectors and values.

The relative errors of the different methods are shown in FIG. 3a. CUR-SVD has a comparable approximation accuracy to SVD and SVD_randQB, and outperforms the SVD single pass method.

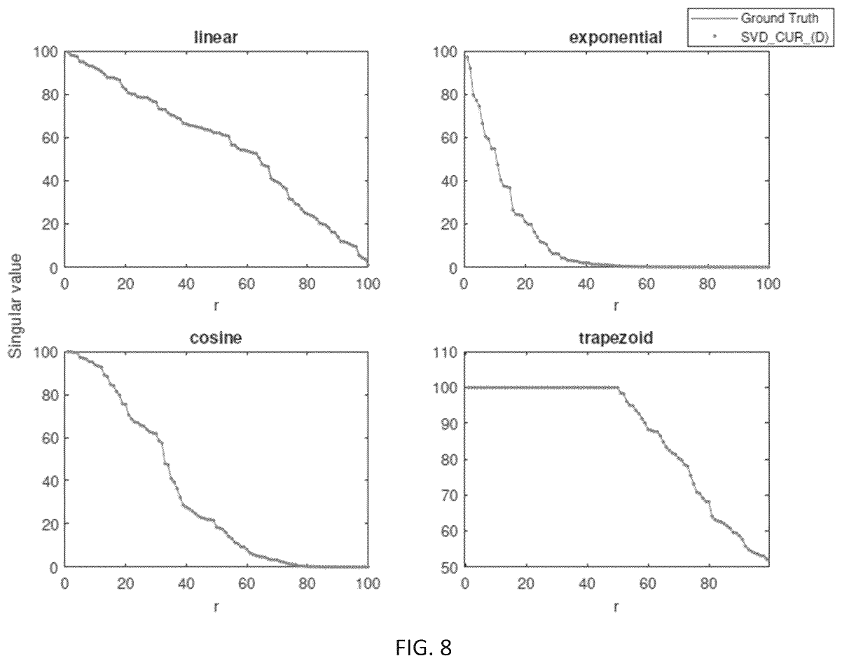

CUR-SVD gives more accurate singular values for three different patterns than randomized and single-pass SVD, especially for the S-shape pattern (FIG. 3b). FIG. 8 shows the error in orthogonality for different singular value patterns by CUR-SVD is very small, around 1e⁻¹⁴, although it is larger than that for the SVD method, which requires the entire matrix A instead of only k rows and columns from A for CUR-SVD.

The timing, approximation error, and memory usage of CUR-SVD to compute the top k-SVD for k=100 and 200 from large-scale matrices are given in Table 1. For the top 200 singular vectors and values of a 1 million by 1 million matrix, about 82 seconds and only 3.052 GB of memory are required to give an approximation error of about 1.2e⁻¹². This is superior to current state of the art methods in terms of data storage and computing time requirements.

TABLE 1

| | | | | Memory |
|---|---|---|---|---|
| n | k | Time (s) | pᵢ(E) | usage (MB) |
| 100,000 | 100 | 1.19 | 5.1e−04 | 152.60 |
| | 200 | 2.91 | 1.8e−12 | 305.18 |
| 200,000 | 100 | 1.92 | 4.2e−04 | 289.36 |
| | 200 | 8.63 | 5.2e−13 | 606.36 |
| 300,000 | 100 | 3.42 | 4.9e−04 | 457.80 |
| | 200 | 20.43 | 1.6e−12 | 915.50 |
| 400,000 | 100 | 6.23 | 4.5e−04 | 610.36 |
| | 200 | 19.10 | 1.9e−12 | 1220.74 |
| 500,000 | 100 | 10.90 | 4.7e−04 | 762.95 |
| | 200 | 18.60 | 1.8e−12 | 1525.91 |
| 600,000 | 100 | 8.24 | 4.6e−04 | 915.53 |
| | 200 | 50.63 | 2.0e−12 | 1831.10 |
| 700,000 | 100 | 17.31 | 4.5e−04 | 1068.12 |
| | 200 | 66.26 | 1.6e−12 | 2136.17 |
| 800,000 | 100 | 21.41 | 4.6e−04 | 1220.75 |
| | 200 | 78.29 | 2.9e−13 | 2441.35 |
| 900,000 | 100 | 36.70 | 4.3e−04 | 1373.30 |
| | 200 | 82.15 | 3.0e−13 | 2746.59 |
| 1,000,000 | 100 | 43.05 | 4.3e−04 | 1510.06 |
| | 200 | 81.94 | 1.2e−12 | 3051.80 |

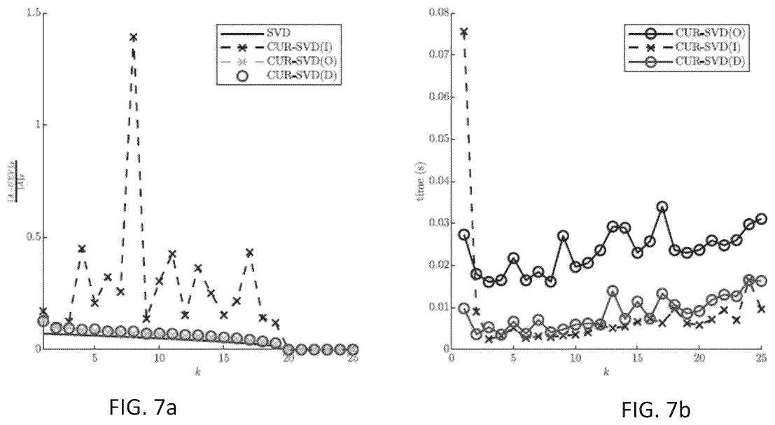

FIG. 7 shows that the singular values from CUR-SVD are almost identical to the ground truth data for different low-rank singular value patterns. The original matrix takes around 7.27 TB of memory, which is impractical. However, CUR-SVD effectively calculates the SVD result of the matrix with 3.052 GB of memory used. To evaluate CUR-SVD methods relative to SVD for PCA, the facial recognition benchmark dataset was used. CUR-SVD was 12 times faster than SVD when computing the top 300 singular vectors and their corresponding singular values of the Yale Extended B dataset, with high approximation accuracy.

By projecting one of the test images onto UU^{T} of SVD and CUR-SVD while changing the number of singular vectors of U from 20 to 300 in steps of 20, the reconstructed faces shown in FIGS. 6c and 6d are obtained, demonstrating the accuracy of the CUR-SVD method. FIG. 6e shows the accuracy of the singular values of CUR-SVD.

Projecting 128 test images of two persons with PCA by the SVD and CUR-SVD methods, shows their clear separation and classification (FIG. 6f, for the fifth and sixth PCA modes) and the accuracy of CUR-SVD.

### Fixed Precision CUR-SVD Method

The fixed-precision CUR-SVD method estimates an accurate rank k and simultaneously computes the SVD without having to store the whole data set and approximated matrices, making it highly efficient in computational time and storage.

For a large-scale matrix A ε [symbol] with low-rank structure rank(A)=ρ<<min{m,n} and C and R from a CUR decomposition, if rank(C)=rank(A)=rank(R), then rank(U)=rank(A) and A≈CUR with high probability. Suppose the number of columns selected to form C is c>>ρ, then

$$rank ( C ) \approx rank ( A ) = ρ \qquad ( 2.2 \text{.1} )$$

By applying thin SVD on C as, C=U_{c}S_{c}V_{c}^{T}, S_{c} ε [symbol] has the singular values of C,s₁, . . . ,s_{ρ}, . . . , s_{c} in descending order. For k<ρ<c,

$${‖ C - {C}_{k} ‖}_{2} = {s}_{k + 1} and {‖ C - {C}_{k} ‖}_{F}^{2} = {\sum }_{j = k + 1}^{ρ} {s}_{j}^{2} \qquad ( 2.2 \text{.1} )$$

If rank k is set to be ρ<k<c, then

$${‖ C - {C}_{k} ‖}_{2} = {s}_{ρ + 1} \approx {‖ A - {A}_{k} ‖}_{2} = {σ}_{ρ + 1} and {‖ C - {C}_{k} ‖}_{F}^{2} \approx {‖ A - {A}_{k} ‖}_{F}^{2} \qquad ( 2.2 \text{.3} )$$

Similarly for the R matrix by constructing R with r>ρ rows and truncating R with rank k>ρ,

$${‖ R - {R}_{k} ‖}_{2} \approx {‖ {A}^{T} - {A}_{k}^{T} ‖}_{2} = {σ}_{ρ + 1} and {‖ R - {R}_{k} ‖}_{F}^{2} \approx {‖ A - {A}_{k} ‖}_{F}^{2} \qquad ( 2.2 \text{.4} )$$

For fixed precision algorithms, the goal is to make ∥A−Aₖ∥₂<ε, where ε is the error tolerance, and find k that satisfies ∥A−Aₖ∥₂<<ε or find k that makes σᵢ(A) almost fixed for i=k+1, . . . ,min {m,n}. This requires computing the SVD of A, increasing the rank k and checking its singular values (i.e., σᵢ(A)) until almost fixed. Computing σᵢ(A) is impractical for large-size matrices. Fixed rank CUR-SVD can overcome this computational and storage complexity by selecting k columns and rows, and computing the k-SVD using Algorithm 1. Then the number of rows and columns selected can be increased and the k-SVD recomputed until σᵢ(A) is almost fixed.

Re-computing k-SVD using fixed rank CUR-SVD is the main computational cost in the algorithm and, as the number of selected rows and columns in each iteration is increased, the SVD of C and R must be re-computed, so embodiments of the invention propose to use the computed singular vectors and corresponding singular values from the previous iteration to compute k-SVD of the current iteration. Incremental SVD (presented in Algorithm 4) is used to re-compute the SVD of C and R in each iteration, decreasing computational complexity.

For C ε [symbol] with c>>ρ and rank(C)≈rank(A)≈ρ and R ε [symbol] with r>>ρ and rank(R)≈rank(A)=ρ, then, rank(U)≈rank(A)=ρ, and A=CUR. Hence,

$${σ}_{i} ( A ) \approx {σ}_{j} ( C ) \approx {σ}_{j} ( R ) \qquad ( 2.2 \text{.5} )$$

$$for i = ρ + 1 , … , min \{ m , n \} and j = ρ + 1 , … , min \{ c , r \} .$$

The stopping condition is the minimum value of j at which the singular values of both C and R become almost fixed. For C, let δ_{c}=|σ_{c}^{k}−σ_{c}^{k-1}| where σₓⁱ is i-th singular value of X and for R, δᵣ=|σᵣ^{j}−σᵣ^{j-1}|. Therefore, δ_{c} and δᵣ both need to be smaller than the tolerance parameter, ε.

The Algorithm 2 below presents fixed precision CUR-SVD.

Algorithm 2: Fixed precision k-SVD for low-rank matrices

Input: A ∈ [symbol] , ϵ, b is the number of selected
rows/columns in each iteration {block size}.
Output: Uk, Σk and Vk, with A ≈ UₖΣₖVₖ^{T}
Initialization:

| | |
|---|---|
| 1. | I ← Uniformly and independently generated m row indices; |
| 2. | J ← Uniformly and independently generated n column indices; |
| 3. | Set σ_{c}^{init} ≡ ∞; and σᵣ^{init} ≡ ∞; |
| 4. | Read the first b selected columns to form C= A(:,J(1: b)); |
| 5. | Read the first b selected rows to form R= A(I(1: b), :); |

Procedures:

| | | |
|---|---|---|
| 6. | [U_{c},S_{c},V_{c}] = SVD(C); | // Compute the economy-sized SVD C ∈ [symbol] |
| 7. | [Uᵣ,Sᵣ,Vᵣ] = SVD(R); | // Compute the economy-sized of SVD R ∈ [symbol] |
| 8. | δ_{c} = \|σ_{c}^{init} − σ_{c}^{b}\|; | // Where S_{c} = diag(σ_{c}¹, ... , σ_{c}^{b}) |
| 9. | δᵣ = \|σᵣ^{init} − σᵣ^{b}\|; | // Where Sᵣ = diag(σᵣ¹, ... , σᵣ^{b}) |
| 10. | j = b + 1; | // Get more c row indices using DEIM algorithm. |

| 11. | While (δ_{c} > ϵ) && (δᵣ > ϵ) | | |
|---|---|---|---|
| 12. | \| | k = j + b − 1 | |
| 13. | \| | Get the next b columns to form C′ = A(:,J((j: k)); | |
| 14. | \| | Get the next b rows to form R′ = A(:(I((j: k), :); | |
| 15. | \| | [U_{c},S_{c},V_{c}] = IncSVD(U_{c},S_{c},V_{c},C′); | |
| 16. | \| | [Uᵣ,Sᵣ,Vᵣ] = IncSVD(Uᵣ,Sᵣ,Vᵣ,C′); | |
| 17. | \| | δ_{c} = \|σ_{c}^{k} − σ_{c}^{k-1}\|; δᵣ = \|σᵣ^{k} − σᵣ^{k-1}\|; j = k + 1 | |
| 18. | \| | C = [C, C′] | // Updated C ∈ [symbol] matrix after reading b columns. |
| 19. | \| | R = [R, R′] | // Updated R ∈ [symbol] matrix after reading b rows. |

| | |
|---|---|
| 20. | end while |

| 21. | Get k more columns indices, c′ = DEIM(Vᵣ); | |
|---|---|---|
| 22. | Get k more row indices, r′ = DEIM(U_{c}); | |
| 23. | c = unique [J(1 : k),c′]; Cᵤ = C(c, :); | |
| 24. | r = unique [I(1 : k),r′]; Rᵤ = R(:, r); | |
| 25. | Compute U = Cᵤ^{†}A(r,c)R_{U}^{†}; | |
| 26. | Compute the intermediate matrix Z = ScVcTUUrSr; | // Where Z ∈ [symbol] |

| | | |
|---|---|---|
| 27. | [U_{Z},S_{Z},V_{Z}] = SVD(Z); | // Compute the full-sized SVD of Z |
| 28. | Set Uₖ ≡ U_{c}U_{Z}, Σₖ ≡ S_{Z}, Vₖ ≡ V_{Z}Vᵣ; | |

The inputs are a large-scale matrix A→ [symbol] , the tolerance parameter ε, and block size b, which is the increment in the number of rows and columns to be incremented in each iteration. For simplicity, in this embodiment, it is assumed c=r.

Initialization step: The column and row indices, J and I, are generated using a uniform sampling strategy, and b columns and rows of A corresponding to the first b indices are read to construct C and R.

Procedures: The SVD of C and R are computed, and δ_{c} a nd δᵣ are initialized. If necessary, new blocks of b columns and b rows of A corresponding to the second subsets of indices J and I are read (from hard disk) to memory to construct the new matrices C′ and R′, the SVD of C and R are updated using IncSVD (the incremental SVD Algorithm 4) with δ_{c} and δᵣ updated.

In one embodiment of the present invention, the main algorithm of incremental SVD by Brand is implemented with two modifications. The main algorithm is modified to deal with a block of columns instead of one column in each iteration, and the modified Gram-Schmidt Algorithm 4 for reorthogonalization after each iteration. The notation A (:, 1: [symbol] ) and [symbol] refer to the first [symbol] columns of A, and the function diag: [symbol] → [symbol] takes as input a vector and returns a square matrix with the input vector entries as its diagonal elements. Let A be a m by n dense matrix and ai refer to the i-th column of A, i.e., A=[a₁|a₂| . . . |aₙ]. Suppose the SVD of the Ae is computed as follows, [symbol] =UΣV^{T}, where U ε [symbol] , Σ ε [symbol] is a diagonal matrix with the [symbol] (ordered) singular values of A [symbol] , and V ε [symbol] .

The incremental SVD aims to update the above U, Σ, and V matrices to find the SVD of [symbol] =[ [symbol] |B], where B ε [symbol] is the new adding matrix of b columns.

Algorithm 4 shows the procedures of the incremental SVD to compute the SVD of [symbol] using the computed SVD of A [symbol] and the new adding columns B.

Algorithm 4: Block Incremental SVD

| 1 | | Function IncSVD(U ∈ [symbol] , Σ ∈ [symbol] , V ∈ [symbol] , B ∈ [symbol] ): | |
|---|---|---|---|
| 2 | \| | /* where B = A(:, [symbol] + 1 : [symbol] + b − 1) | */ |
| 3 | \| | [symbol] = size (U, 2); c = [symbol] + b; | // Output dimensions |
| 4 | \| | E = U^{T}B; | // E ∈ [symbol] |
| 5 | \| | T = B − UE; | // Residual of projecting B onto columns span of U. |
| 6 | \| | [Q_{T}, R_{T}] = modified gram Schmidt(T); | |
| 7 | \| | $Set M = [ \begin{matrix}Σ & E \\ 0 & {R}_{T}\end{matrix} ] ; and find its SVD as , [ {U}_{M} , {Σ}_{M} , {V}_{M} ] = SVD ( M ) ;$ | // M ∈ R^{c×c} |
| 8 9 | \| \| | $Set R = [ \begin{matrix}V & 0 \\ 0 & I\end{matrix} ] ;$ $Set Q = [ \begin{matrix}U & {Q}_{T}\end{matrix} ] ;$ | // Prepare V Update via Q ∈ R^{c×c} // Prepare U Update via Q ∈ R^{m×c} |
| 10 | \| | [Q_{Q}, ~] = modified gram schmidt(Q); | // Reorthogonalization |
| 11 | \| | U ← Q_{Q}U_{M}; | // Update U to be of size m × c |
| 12 | \| | Σ ← Σ_{M}; | // Update Σ to be of size c × c |
| 13 | \| | V ← RV_{M}; | // Update V to be of size c × c |

| | | |
|---|---|---|
| 14 | \| | return U, Σ, V. |

Algorithm 5: A modified Gram-Schmidt method

| 1 | Function modified gram Schmidt(A): | | |
|---|---|---|---|
| 2 | \| | [m, n] = size(A); | // Output dimensions |
| 3 | \| | for j = 1 to n do | |

| 4 | \| | \| | Set a = A(:, j); | |
|---|---|---|---|---|
| 5 | \| | \| | for i = 1 to j − 1 do | |
| 6 | \| | \| | \| | R(i,j) = Q(:,i)T α; |
| 7 | \| | \| | \| | α = α − R(i,j)Q(:,i); |

| | | | |
|---|---|---|---|
| 8 | \| | \| | end for |
| 9 | \| | \| | R(j,j) = \sqrt{α^{T}α} |
| 10 | \| | \| | Q(:,j) =a/R(j,i); |

| | | |
|---|---|---|
| 11 | \| | end for |
| 12 | \| | return Q, R, |

If the stopping condition ((δ_{c}<ε) && (δᵣ<ε) is satisfied, then the estimated rank k is k=e×b, where e is the number of times the stopping condition was invalid. The final C ε [symbol] and R ε [symbol] matrices and their SVD [U_{c}, S_{c}, V_{c}] and [Uᵣ, Sᵣ, Vᵣ], are the final results from IncSVD In Lines 15 and 16. Thus, the rank k and the SVD of C and R matrices are computed simultaneously.

As with the fixed rank CUR-SVD algorithm, after constructing C and R, the U matrix is computed. Finally, the intermediate matrix Z and its SVD [U_{z}, S_{z}, V_{z}] are computed to give Uₖ ε [symbol] , Σ ε [symbol] , Vₖ ε [symbol] , with A≈UₖΣₖVₖ^{T}.

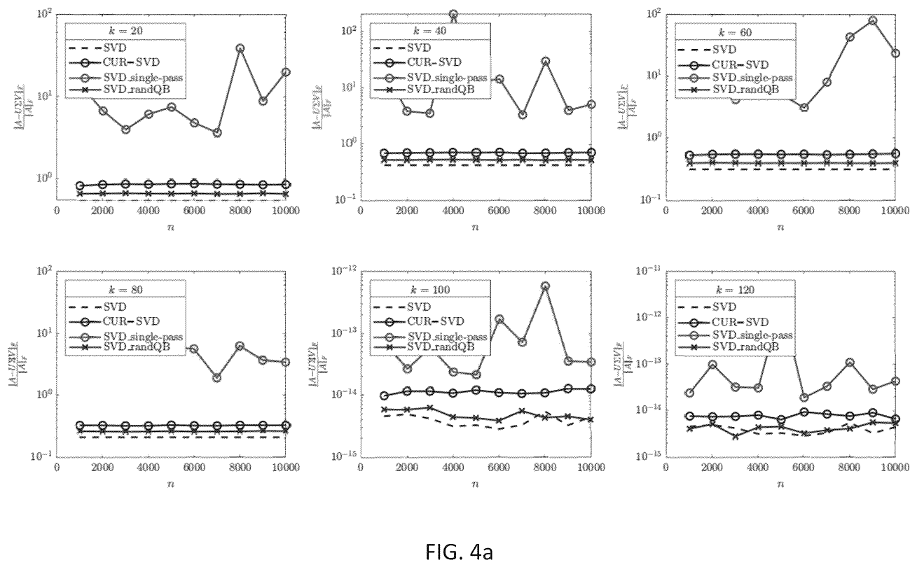

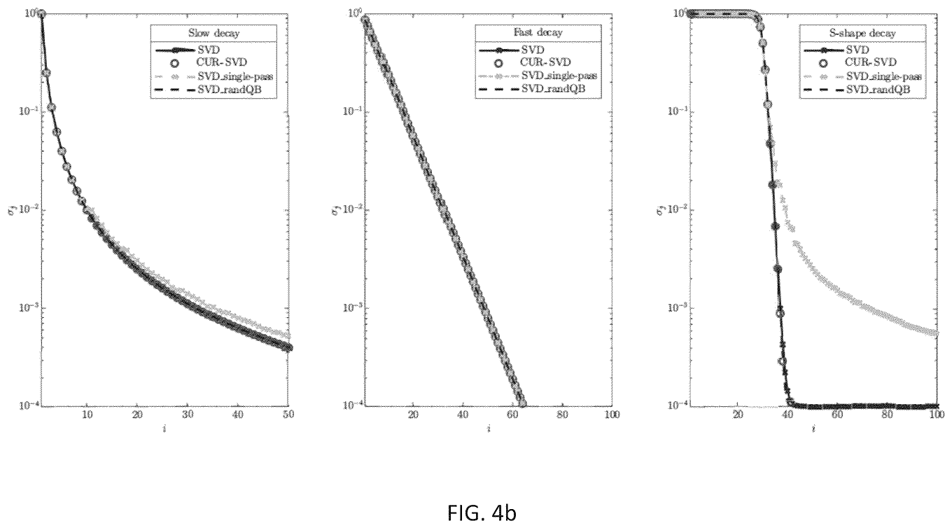

The effect of all parameters, (error tolerance c, block size b, and size of the matrix n) on the estimated rank \hat{k}, run time, estimated error pₙ(E), and memory usage by the fixed precision CUR-SVD algorithm for different tolerance parameters (by row) are given in FIG. 4a. The actual rank of the data matrices was 150, with the distribution of a singular value at β=0.5. CUR-SVD had much better performance in computational time and storage usage, with a relatively similar approximation error to the truncated SVD method (FIG. 4b).

For a large error tolerance, ε=1e⁻³, the estimated rank \hat{k} is far from the actual rank k, especially for small block sizes b (first row, FIG. 4a), giving a larger approximation error pₙ(E) although run time and memory usage are very small. At an error tolerance of ε of 1e⁻⁸ (the second row of FIG. 4a), the estimated rank \hat{k} is almost the actual rank, especially for small block sizes, with a run time of 18 seconds, small pₙ(E) of about 5e⁻¹², and memory usage of about 50 MB, to compute the first 160 singular values and vectors of a 20000×20000 matrix. Tradeoffs between ε and approximation accuracy and between block size b and time and space complexity must be made. From experiments, it is suggested to set ε to 1e⁻⁸ to ensure a tiny approximation error and b to 20 for effective time and space usage.

Tables 2 and 3 show the performance of the fixed-precision CUR-SVD algorithm for small-and large-scale matrices, respectively. The actual rank of the generated data was 150, the block size b was 20, and the error tolerance parameter ε was set to 1e⁻⁸. The estimated rank was 180 under different values of β. Therefore, CUR-SVD accurately estimated the number of columns and rows (i.e., estimated rank) that guarantee high approximation accuracy. For the 1,000,000 by 1,000,000 matrix, CUR-SVD required about 2.71 GB of memory to compute the first 180 singular vectors and singular values in about 15 minutes. The estimated error pᵢ(E) was about 1e⁻¹³ for different matrix sizes and patterns of singular values.

TABLE 2

| Decay | | Estimated | | | Memory |
|---|---|---|---|---|---|
| parameter | n | \hat{k} | Time (s) | pᵢ(E) | usage (MB) |
| | 10,000 | 240 | 9.63 | 1.4e−14 | 52.45 |
| | 20,000 | 240 | 20.12 | 1.6e−14 | 69.03 |
| | 30,000 | 240 | 23.17 | 2.0e−14 | 109.87 |
| | 40,000 | 240 | 28.20 | 1.3e−14 | 147.71 |
| β = 0.5 | 50,000 | 240 | 30.66 | 2.5e−14 | 183.14 |
| | 60,000 | 240 | 34.59 | 2.2e−14 | 219.73 |
| | 70,000 | 240 | 39.80 | 2.4e−14 | 256.32 |
| | 80,000 | 240 | 42.45 | 4.2e−14 | 293.01 |
| | 90,000 | 240 | 44.42 | 1.8e−14 | 329.66 |
| | 100,000 | 240 | 47.21 | 2.7e−14 | 366.19 |
| | 10,000 | 240 | 10.18 | 4.7e−14 | 35.62 |
| | 20,000 | 240 | 19.82 | 4.8e−14 | 73.25 |
| | 30,000 | 240 | 21.72 | 2.2e−14 | 109.87 |
| | 40,000 | 240 | 29.45 | 3.8e−14 | 146.21 |
| β = 1 | 50,000 | 240 | 31.73 | 5.1e−14 | 183.11 |
| | 60,000 | 240 | 34.98 | 3.5e−14 | 219.73 |
| | 70,000 | 240 | 41.49 | 6.1e−14 | 256.35 |
| | 80,000 | 240 | 41.03 | 2.7e−14 | 292.50 |
| | 90,000 | 240 | 43.71 | 2.9e−14 | 329.66 |
| | 10,0000 | 240 | 47.96 | 3.9e−14 | 367.10 |
| | 10,000 | 240 | 10.54 | 2.3e−13 | 20.73 |
| | 20,000 | 240 | 20.87 | 1.3e−13 | 73.25 |
| | 30,000 | 240 | 22.18 | 1.2e−13 | 109.60 |
| | 40,000 | 240 | 29.76 | 1.1e−13 | 146.52 |
| β = 1.5 | 50,000 | 240 | 29.90 | 1.7e−13 | 183.08 |
| | 60,000 | 240 | 32.76 | 6.2e−14 | 219.71 |
| | 70,000 | 240 | 40.78 | 1.3e−13 | 256.31 |
| | 80,000 | 240 | 44.07 | 2.7e−13 | 293.04 |
| | 90,000 | 240 | 44.45 | 4.7e−13 | 329.59 |
| | 100,000 | 240 | 47.63 | 8.8e−14 | 366.25 |
| | 10,000 | 240 | 10.23 | 1.1e−12 | 36.62 |
| | 20,000 | 220 | 15.15 | 3.3e−12 | 67.11 |
| | 30,000 | 220 | 17.48 | 2.0e−12 | 100.71 |
| | 40,000 | 240 | 28.14 | 1.7e−12 | 146.25 |
| β = 2 | 50,000 | 220 | 24.10 | 1.0e−11 | 167.85 |
| | 60,000 | 220 | 26.16 | 5.4e−12 | 201.34 |
| | 70,000 | 220 | 31.09 | 1.8e−12 | 234.99 |
| | 80,000 | 220 | 31.95 | 1.2e−12 | 268.59 |
| | 90,000 | 220 | 34.30 | 1.1e−12 | 302.12 |
| | 100,000 | 220 | 36.65 | 4.4e−12 | 335.76 |

TABLE 3

| Decay | | Estimated | Time | | Memory |
|---|---|---|---|---|---|
| parameter | n | \hat{k} | (s) | pᵢ(E) | usage (MB) |
| β = 0.5 | 200,000 | 180 | 154.02 | 2.3e−14 | 563.61 |
| | 300,000 | 180 | 231.57 | 1.9e−14 | 823.01 |
| | 400,000 | 180 | 309.25 | 2.8e−14 | 1094.67 |
| | 500,000 | 180 | 385.27 | 2.1e−14 | 1356.88 |
| | 600,000 | 180 | 473.38 | 1.4e−14 | 1631.60 |
| | 700,000 | 180 | 556.28 | 2.2e−14 | 1906.29 |
| | 800,000 | 180 | 638.09 | 1.9e−14 | 2181.02 |
| | 900,000 | 180 | 821.95 | 1.9e−14 | 2483.71 |
| | 1,000,000 | 180 | 853.28 | 1.6e−14 | 2745.59 |
| β = 1 | 200,000 | 180 | 156.02 | 2.2e−14 | 549.25 |
| | 300,000 | 180 | 225.76 | 2.8e−14 | 823.54 |
| | 400,000 | 180 | 304.17 | 2.3e−14 | 1098.67 |
| | 500,000 | 180 | 389.84 | 3.5e−14 | 1373.23 |
| | 600,000 | 180 | 469.46 | 3.3e−14 | 1646.98 |
| | 700,000 | 180 | 555.14 | 5.4e−14 | 1921.64 |
| | 800,000 | 180 | 644.51 | 3.2e−14 | 2196.27 |
| | 900,000 | 180 | 837.75 | 3.7e−14 | 2466.79 |
| | 1,000,000 | 180 | 878.70 | 2.9e−14 | 2746.55 |
| | 200,000 | 180 | 155.76 | 9.1e−14 | 548.85 |
| | 300,000 | 180 | 226.11 | 2.2e−13 | 823.45 |
| | 400,000 | 180 | 304.19 | 1.6e−13 | 1098.14 |
| β = 1.5 | 500,000 | 180 | 382.07 | 2.0e−13 | 1371.86 |
| | 600,000 | 180 | 486.69 | 8.2e−14 | 1646.98 |
| | 700,000 | 180 | 557.45 | 1.7e−13 | 1921.57 |
| | 800,000 | 180 | 664.55 | 1.8e−13 | 2196.27 |
| | 900,000 | 180 | 750.95 | 1.5e−13 | 2467.82 |
| | 1,000,000 | 180 | 925.33 | 2.5e−13 | 2745.55 |
| β = 2 | 200,000 | 180 | 154.55 | 1.7e−12 | 548.82 |
| | 300,000 | 180 | 225.62 | 1.9e−12 | 823.51 |
| | 400,000 | 180 | 303.32 | 1.3e−12 | 1098.64 |
| | 500,000 | 180 | 389.23 | 1.1e−12 | 1372.30 |
| | 600,000 | 180 | 469.96 | 1.9e−12 | 1646.95 |
| | 700,000 | 180 | 557.59 | 1.4e−12 | 1921.61 |
| | 800,000 | 180 | 657.26 | 1.3e−12 | 2196.27 |
| | 900,000 | 180 | 718.50 | 2.8e−12 | 2480.91 |
| | 1,000,000 | 180 | 852.26 | 9.7e−13 | 2739.03 |

Embodiments of the present invention presents a novel method to compute the top k-SVD of an extremely large-scale, low rank matrix that is prohibitive with existing SVD algorithms. CUR-SVD is based on randomly observing a part of the data using CUR decomposition. Two algorithms, fixed k-rank and fixed precision CUR-SVD, were developed for different low-rank approximation problems and achieved comparable approximation accuracy to the optimal reduced SVD algorithm. Instead of analyzing the whole matrix, these methods act via CUR decomposition and have higher efficiency than traditional SVD algorithms. When only a small portion of matrix entries are observed, the method can perform SVD on extremely large-scale matrices that cannot be loaded into computer memory, and does this in much less time than a standard method would need.

### 1 Methods

The performance of CUR-SVD was evaluated by comparing it with widely used methods for computing SVD. The MATLAB built-in command for truncated SVD, based on a Krylov subspace iterative method, was used and designated as SVD. For randomized SVD methods, two widely used methods, SVD randQB and SVD single pass, which are the primary randomized method and a single pass randomized SVD, respectively, were used for the performance comparison. The relative error and run-time are reported for all experiments as the average over ten trials. The relative errors in the Frobenius norm were used as an accuracy metric of the approximation, defined as,

$$\frac{{‖ A - U \sum {V}^{T} ‖}_{F}}{{‖ A ‖}_{F}} .$$

For low-rank matrices, the matrix is generated directly based on SVD. Let V ε [symbol] and W ε [symbol] be two randomly generated real unitary matrices, and Σ ε [symbol] be a non-negative real diagonal matrix with manually set diagonal values. The low-rank matrix A ε [symbol] will be represented as A=VΣW^{T}. Results were compared with the ground truth of the generated data for experiments on large-scale matrices, as the existing SVD algorithms cannot handle such huge matrices.

### Fixed Rank CUR-SVD

To evaluate the performance of CUR-SVD in handling the U matrix (as shown in FIG. 6), a random matrix A of size 5,000 by 5,000 with rank 20 was generated, and the k-SVD was computed using SVD and fixed rank CUR-SVD, with different constructions of the U matrix of CUR. CUR-SVD with the U matrix based on the intersection, the optimal solution, and the method based on DEIM, are denoted as CUR-SVD(I), CUR-SVD(O), and CUR-SVD(D), respectively. The value of k was changed from 1 to 25, and the relative error and run time were computed for each value.

To evaluate the computational and space efficiency of the fixed-rank CUR-SVD method, randomized SVD based on QB decomposition and single pass SVD are used in one embodiment of the present invention. A set of different-size matrices was generated with a rank of 100, and the singular values were chosen as Σₖ=diag(1^{-β},2^{-β}, . . . ,k^{-β}) for the singular values decay parameter β=0.5, as shown in FIG. 3. For randomized SVD and single-pass SVD, the oversampling parameter was set to 10. For each matrix size, algorithms were run to compute the top k singular values and singular vectors, where k changes from 20 to 120 in steps of 20 (for CUR-SVD, k is the number of columns and rows selected to form C and R matrices).

To check the accuracy of the resultant singular values and vectors by CUR-SVD, three types of matrices were generated to stand for different distribution shaped (slow, fast, and S-shape) decays of singular values. The singular vectors U and V were random matrices with orthonormal columns and the diagonal elements of Σ were σⱼ=e^{-j/2}, σⱼ=e^{-j/7}, and σⱼ=0.0001+(1+e^{j-30})⁻¹ for slow, fast, and S-shape decays, respectively. A matrix A ε [symbol] was generated for each pattern of singular values and the top 200 singular vectors and singular vectors of A were computed using different methods.

In one embodiment of the present invention, the orthogonality of the resultant singular vectors can be evaluated by this proposed method: three matrices are generated in the same manner as mentioned above. The k-SVD is computed using SVD and the proposed methods for each matrix, where changes from 10 to 200 with step 10. For each k value, the orthogonality of computed left and right singular vectors is computed as,

$${‖ {I}_{k} - {U}_{k}^{T} {U}_{k} ‖}_{∞} and {‖ {I}_{k} - {V}_{k}^{T} U {V}_{k} ‖}_{∞} \qquad ( 4. \text{.1} )$$

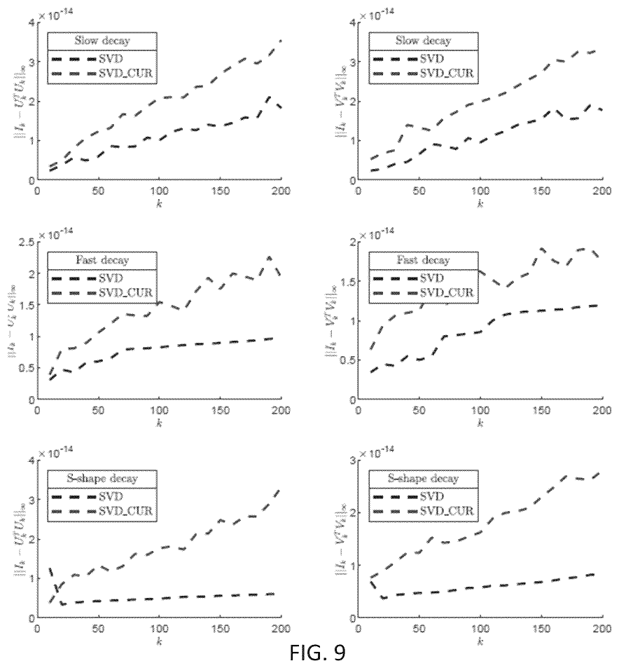

respectively, where ∥x∥_{∞}=max|xᵢ|. Reference is made to FIG. 9 which shows the graphs illustrating the accuracy validation of singular vectors computed by fixed rank k algorithm compared to SVD method under different singular values distributions.

To evaluate CUR-SVD with large-scale matrices, the classical power method to estimate the spectral norm of error between the actual data matrix and approximated matrix by the proposed method was utilized.

For large-scale data (Table 1), a set of matrices of sizes starting from 100,000 by 100,000 to 1 million by 1 million was generated with a rank 150 and slow decay distribution of singular values. For each matrix, the rank k (the number of rows and columns selected to construct CUR) was set to 100 or 200. CUR-SVD was applied to large-scale matrices of size 1 million by 1 million with four different singular values distributions: linear-, polynomial-, cosine-, and trapezoid-like with actual ranks of 100, (FIG. 8).

In order to evaluate CUR-SVD methods compared to SVD for PCA, the facial recognition benchmark dataset was used. The Yale Extended B dataset contains images of 38 individuals, and each has 64 images under different lighting conditions, as shown in FIGS. 6a and 6b. Each image has 192 168 pixels and was reshaped into a large column vector of 32, 256 elements. In this example, images of 36 individuals were selected for training and applied the SVD and CUR-SVD methods to the faces data matrix. The k parameter of CUR-SVD is set to 300.

### Fixed Precision CUR-SVD

A matrix Aₖ can be specified in terms of the three matrices Uₖ, Σₖ, and Vₖ of its k-SVD. The matrices Uₖ and Vₖ were generated randomly from a normal distribution, then QR factorization was used to obtain the orthonormal ma trices of sizes m×k and k×n, respectively. The singular values of Aₖ
for four values of the singular values decay parameter,
   β ε {0.5, 1.0, 1.5, 2.0}. Small and large-size matrices were used to evaluate the performance of CUR-SVD (Tables. 2 and 3 above, respectively). Small size matrices, A ε [symbol] , had n change from 10,000 to 100,000 in steps of 10,000. Large-sized matrices had n change from 200,000 to 1,000,000 in steps of 100,000.

For each set of configurations, the computational time, memory usage, estimated rank k, and estimated error pᵢ(E) are presented. Give a matrix A ε [symbol] , there is provided a random column vector ω ε [symbol] with independent and identically distributed elements, each distributed as a Gaussian random variable of zero mean and unit variance. Let \ddot{ω} ε [symbol] a column vector, \ddot{ω}=ω/∥ω∥₂. Then the estimated spectral norm of A at i-th step of the power iteration method is given by,

$${p}_{i} ( A ) = \sqrt{\frac{{‖ {( {A}^{T} A )}^{i} \ddot{ω} ‖}_{2}}{{‖ {( {A}^{T} A )}^{i - 1} \ddot{ω} ‖}_{2}}}$$

For a large value of i, pᵢ(A) estimates the value of ∥A∥₂ with high probability. In this example embodiment, usage of i=30 to ensure an accurate estimation.

Suppose Uₖ, Σₖ and Vₖ the actual decomposed matrices by k-SVD with A=UₖΣₖVₖ^{T}. Let Ûₖ, \hat{Σ}ₖ and \hat{V}ₖ the output matrices from the proposed method. Then the reconstructed matrix A=Ûₖ\hat{Σ}ₖ\hat{V}ₖ^{T}. It is infeasible to compute the error between the original data matrix A and approximated matrix Â as ∥A−Â∥₂ for large-scale matrices because of the multiplication computational complexity to compute A and Â, and their storage cost. However, to avoid the complexity of computing A and Â by estimating the spectral norm of error between them directly as follows, let E=A−Â=UₖΣₖVₖ^{T}−Ûₖ\hat{Σ}ₖ\hat{V}ₖ^{T}, then

$${p}_{i} ( E ) = \frac{{‖ {( {E}^{T} E )}^{i} \ddot{ω} ‖}_{2}}{{‖ {( {E}^{T} E )}^{i - 1} \ddot{ω} ‖}_{2}}$$

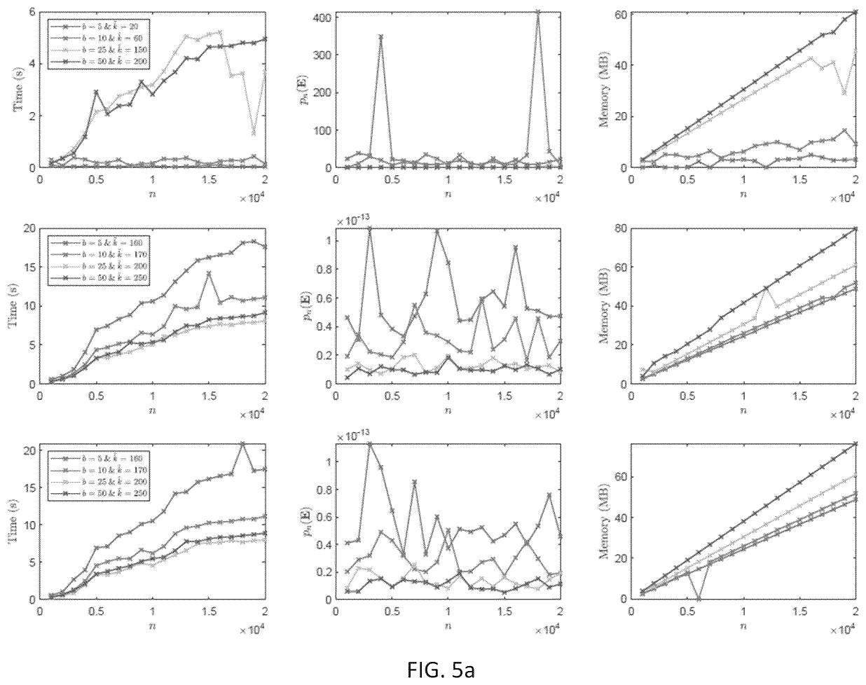

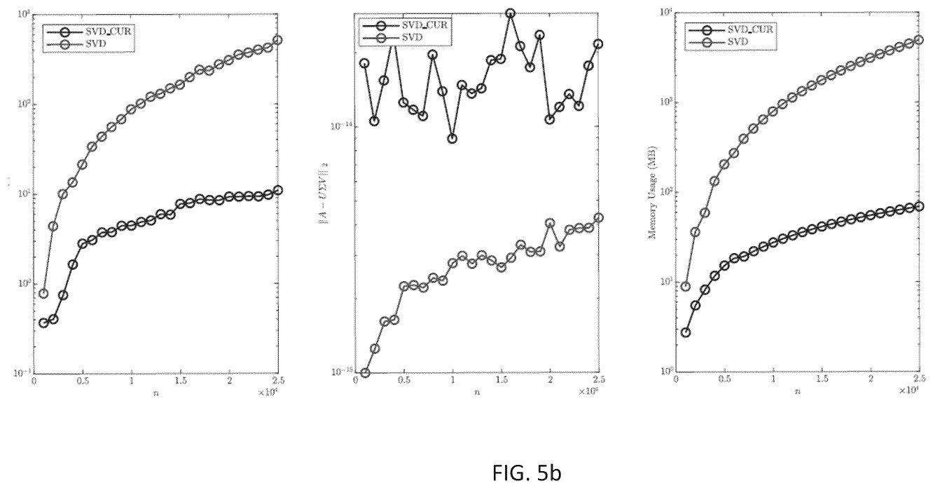

With high probability pᵢ(E) estimates the value of ∥UₖΣₖVₖ^{T}−Ûₖ\hat{Σ}ₖ\hat{V}ₖ^{T}∥₂. To evaluate the performance of the fixed precision CUR-SVD algorithm compared to SVD by MATLAB, matrices with sizes from 1,000 to 25,000 in steps of 1,000 were generated with the parameter settings given above. The timing, estimated error pᵢ(E), and memory usage for each matrix size for different decay of singular values distribution β=0.5 were reported (FIG. 5b).

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilized. This will include tablet computers, wearable devices, smart phones, Internet of Things (IoT) devices, edge computing devices, standalone computers, network computers, cloud-based computing devices and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A computer-implemented method for generating an approximation image of a matrix A, the computer-implemented method comprising:
constructing in a processing unit a C, U, R matrices decomposition of matrix A wherein C comprises k column vectors and R comprises k row vectors retrieved from a storage memory holding the matrix A;
performing in the processing unit Singular Value Decomposition on the C, U, and R to generate the approximation matrix UₖΣₖVₖ^{T} of the matrix A such that A≈UₖΣₖVₖ^{T}.

2. The computer-implemented method of claim 1, wherein the C and R matrices comprises rows and columns of A given by indices I and J generated randomly from a uniform distribution.

3. The computer-implemented method of claim 2, wherein the matrix U is an optimal solution of U=Cᵤ^{†}AᵤRᵤ^{†}, wherein row and column of Cᵤ, Aᵤ, and Rᵤ are retrieved from the storage memory holding the matrix A using deterministic sampling method.

4. The computer-implemented method of claim 3, wherein the deterministic sampling method is a discrete empirical interpolation method (DEIM).

5. The computer-implemented method of claim 4, wherein step of the Singular Value Decomposition on the C, U, and R comprising generating matrices [U_{c},S_{c},V_{c}] and [Uᵣ,Sᵣ,Vᵣ], such that C=U_{c}S_{c}V_{c}^{T} and R=UᵣSᵣVᵣ^{T}.

6. The computer-implemented method of claim 5, wherein the step of Singular Value Decomposition on the C, U, and R comprises the step of generating a matrix Z, such that Z=S_{c}V_{c}^{T}UUᵣSᵣ.

7. The computer-implemented method of claim 6, wherein the approximation matrix UₖΣₖVₖ^{T} is generated by the Singular Value Decomposition on Z, such that Z=U_{z}S_{z}V_{z}^{T}.

8. The computer-implemented method of claim 7, wherein Uₖ=U_{c}U_{z}, Σₖ=S_{z}, and Vₖ=V_{z}Vᵣ.

9. The computer-implemented method of claim 8, wherein k is greater than a rank of the matrix A.

10. The computer-implemented method of claim 8, wherein k is an arbitrary integer.

11. The computer-implemented method of claim 10, wherein an error tolerance e is stored in memory of the processing unit.

12. The computer-implemented method of claim 11, wherein distance functions for the Singular Value Decomposition of C and R, δ_{c}=⊕σ_{c}^{k}−σ_{c}^{k-1}| and δᵣ=|σᵣ^{k}−σᵣ^{k-1}| are generated, wherein S_{c}=diag(σ_{c}¹, . . . ,σ_{c}^{k}) and Sᵣ=diag(σᵣ¹, . . . ,σᵣ^{k}).

13. The computer-implemented method of claim 12, wherein if one of the distance functions returns a value greater than the error tolerance ε,k will be increased to construct in the processing unit a new C, U, R matrices decomposition with increased rows and columns until the distance functions return a value less than the error tolerance ε.

14. The computer-implemented method of claim 1, wherein the processing unit is adapted to compute the approximation matrix UₖΣₖVₖ^{T} using partial elements of the matrix A.

15. The computer-implemented method of claim 14, wherein the processing unit comprises cache memory or random access memory having a size less than a size required to holding the matrix A.

16. The computer-implemented method of claim 15, wherein the processing unit is adapted to load only the partial elements of matrix A to cache memory or random access memory for processing.

17. The computer-implemented method of claim 1, wherein the matrix A comprises a plurality of digital images.

18. The computer-implemented method of claim 17, wherein each digital images is represented as a column vector in matrix A.

19. The computer-implemented method of claim 1, wherein the matrix A comprises time series data wherein each column vector represents a snapshot data of a time interval.
